(19) United States
(12) Patent Application Publication
(10) Pub. No.: US 2017/0117980 A1
(43) Pub. Date: Apr. 27, 2017

(54) TIME SYNCHRONIZATION FOR NETWORK DEVICE

(71) Applicant: ACCTON TECHNOLOGY CORPORATION, HSINCHU (TW)

(72) Inventor: Chen-Chang CHENG, Kaohsiung City (TW)

(21) Appl. No.: 15/144,791

(22) Filed: May 2, 2016

(30) Foreign Application Priority Data
Oct. 27, 2015 (TW) 104135260

(51) Int. Cl. H04J 3/06; H04L 7/04; H04L 7/00

(52) U.S. Cl. CPC H04J 3/0658; H04L 7/0037; H04L 7/04; H04J 3/0682

(57) ABSTRACT

A network device is provided, which includes a communication unit and a processing unit. The communication unit is configured to perform a time setting process with a master clock device. The processing unit is coupled to the communication unit and is configured to control the communication unit to perform a time synchronization process for obtaining a time offset of the network device relative to the master clock device. The processing unit is further configured to calculate a processing time elapsed during the time synchronization process and obtain a correction time by calculating the system time of the network device, the time offset and the processing time.

### RELATED APPLICATIONS

This application claims priority to Taiwanese Application Serial Number 104135260, filed on Oct. 27, 2015, which is herein incorporated by reference.

### BACKGROUND

Field of Invention

The present invention relates to a network device and a time synchronization method that can provide high time synchronization accuracy and a network system using the same.

Description of Related Art

With the development of network technologies, various types of network applications can be realized. For some network applications (such as automatic control, instrument measurement or real-time video surveillance), higher time synchronization accuracy is required for better performance. However, node and terminal devices in a network would be affected by the surrounding environment, resulting in different levels of time shifts of the generated oscillating frequencies and thus degrading synchronization accuracy of the system time of each network device. How to achieve accurate system time synchronization for each device in the network has become one of the major objectives for those skilled in the related art.

FIG. 1 illustrates a message transmission diagram of a time synchronous process performed by a master clock 110 and a slave clock 120. The master clock 110 corresponds to a master clock device, while the slave clock 120 corresponds to a network device or a terminal device connecting to the master clock device. Alternatively, the master clock 110 corresponds to a network device, while the slave clock 120 corresponds to a next-stage network device or a terminal device. The master clock 110 and the slave clock 120 adopt the Precision Time Protocol (PTP) standardized by IEEE to perform message transmission therebetween.

As shown in FIG. 1, according to the PTP, the master clock 110 first sends a synchronization message M1 to the slave clock 120 at time T1, and records the time T1 of sending the synchronization message M1. After sending the synchronization message M1, the master clock 110 generates a follow-up message M2 including information of the time T1, and then sends the follow-up message M2 to the slave clock 120. After receiving the synchronization message M1, the slave clock 120 records time T2 of receiving the synchronization message M1. Next, the slave clock 120 receives the follow-up message M2, and extracts the time T1 in the follow-up message M2, thereby calculating the time difference T21 between the times T1 and T2 (T21=T2−T1). The time difference T21 is namely the time offset TO of the slave clock 120 relative to the master clock 110 plus the propagation delay TD1 of the message sent by the master clock 110 to the slave clock 120.

Then, the slave clock 120 sends a delay request message M3 to the master clock 110 at time T3, and records the time T3 of sending the delay request message M3. After receiving the delay request message M3, the master clock 110 records time T4 of receiving the delay request message M3. The master dock 110 then generates the delay response message M4 including information of the time T4, and sends the delay response message M4 to the slave dock 120. After receiving the delay response message M4, the slave dock 120 extracts the time T4 in the delay response message M4, thereby calculating the time difference T43 between the time T3 and the time T4 (T43=T4−T3). The time difference T43 is the time offset TO of the slave clock 120 relative to the master clock 110 minus the transmission delay TD2 of the message sent by the slave clock 120 to the master clock 110.

By performing the abovementioned time synchronization process, the time difference T21 and the time difference T43 can be obtained, which are respectively TO+TD1 and TO−TD2; that is, T21=TO+TD1 and T43=TO−TD2. Suppose the transmission delay TD1 of the message sent from the master clock 110 to the slave clock 120 is the same as the transmission delay TD2 sent from the slave clock 120 to the master clock 110, the averaged value of the time difference T21 and the time difference T43 is namely the time offset TO of the slave clock 120 relative to the master clock 110. After subtracting the time offset TO from the system time of the slave clock 120, the system time of the slave clock 120 and the system time of the master clock 110 can be synchronized.

However, the slave clock 120 needs some time to calculate the time offset TO. If the time consumed for calculating the time offset TO is not subtracted, there still be a considerable difference between the system time of the slave clock 120 and the system time of the master clock 110 after the time synchronization process.

### SUMMARY

The objective of the present invention is to provide a network device, a time synchronization method and a network system using the same. The present invention can update the system time of a network device more accurately by subtracting the time elapsed during calculation of performing a time synchronization process with a master clock device. Moreover, the synchronous pulse signal generated according to the present invention may be transmitted to other communication devices for performing system time synchronization on the communication devices, and thus the updated system times of these communication devices can be more accurate.

One aspect of the present invention relates to a network device, which includes a communication unit and a processing unit. The communication unit is configured to perform a time synchronization process with a master clock device. The processing unit is coupled to the communication unit. The processing unit is configured to control the communication unit to perform the time synchronization process for obtaining a time offset of the network device relative to the master clock device. The processing unit is further configured to calculate a processing time elapsed during the time synchronization process and to obtain a correction time by calculating a system time of the network device, the time offset and the processing time.

In one or more embodiments, the network device further includes a counting unit which is coupled to the processing unit. The processing unit sets a counting time of the counting unit according to the correction time, and the counting unit generates a synchronous pulse signal according to the counting time.

In one or more embodiments, the network device further includes an output port. The output port is coupled to the counting unit, and is configured to transmit the synchronous pulse signal to a communication device.

In one or more embodiments, the processing unit is further configured to update the correction time by subtracting a transmission delay of the network device from the correction time.

In one or more embodiments, the time synchronization process is a precision time protocol (PTP) process, and the processing time is obtained by the processing unit which subtracts the system time corresponding to receiving a follow-up message from the system time corresponding to calculating the time offset.

Another aspect of the present invention relates to a time synchronization method. The time synchronization method is adapted to a network device, which includes the following steps: performing a time synchronization process with a master clock device for obtaining a time offset of the network device relative to the master clock device; subtracting a system time of the network device corresponding to receiving a follow-up message by the network device from the system time corresponding to calculating the time offset, thereby obtaining a processing time elapsed during calculation of the time synchronization process; obtaining a correction time by calculating the system time of the network device, the time offset and the processing time; and setting a counting time for generating a synchronous pulse signal by the correction time.

In one or more embodiments, the time synchronization method further includes transmitting the synchronous pulse signal to a communication device via an output port of the network device.

In one or more embodiments, the time synchronization method further includes updating the correction time by subtracting a transmission delay of the network device from the correction time.

Another aspect of the present invention relates to a network system. The network system includes a master clock device and a network device. The network device is configured to communicatively connect with the master clock device and to perform a time synchronization process with the master clock device, thereby obtaining a time offset of the network device relative to the master clock device. The network device is further configured to calculate a processing time elapsed during the time synchronization process and to obtain a correction time by calculating a system time of the network device, the time offset and the processing time, so as to set a counting time of the network device for generating a synchronous pulse signal.

In one or more embodiments, the network device is a switch.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings.

FIG. 1 illustrates a message transmission diagram of a time synchronous process performed by a master clock and a slave clock.

FIG. 2 illustrates a schematic diagram of a network system in accordance with some embodiments of the present invention.

FIG. 3 illustrates a schematic diagram of a network device in accordance with some embodiments of the present invention.

FIG. 4 is a flowchart of a time synchronization process in accordance with some embodiments of the present invention.

### DETAILED DESCRIPTION

The detailed explanation of the present invention is described as following. The described preferred embodiments are presented for purposes of illustrations and description, and they are not intended to limit the scope of the present invention.

Terms concerning electrical communications, such as “coupled,” refer to a relationship wherein nodes communicate with one another either directly or indirectly through intervening structure(s), component(s) or element(s), unless otherwise stated or necessary to the operation described.

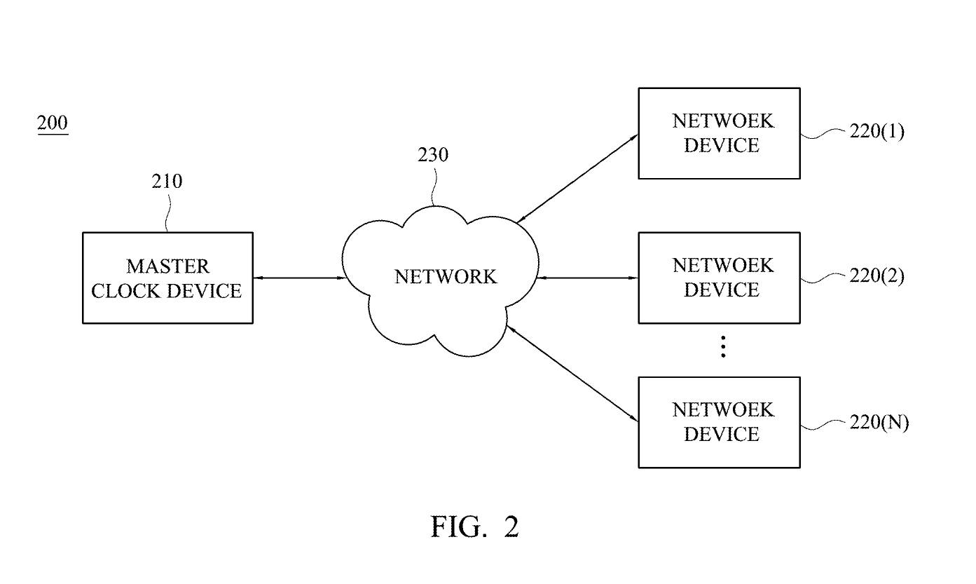

FIG. 2 illustrates a schematic diagram of a network system 200 in accordance with some embodiments of the present invention. The network system 200 includes a master clock device 210, network devices 220(1)-220(N) and a network 230. Each of the network devices 220(1)-220(N) may be an intermediate node device, such as a switch or a router, or may be a terminal device with network connection functionality, such as a personal computer, a web camera or a video player. The network 230 may be a local area network (LAN) or a wide area network (WAN), and the master clock device 210 or the network devices 220(1)-220(N) may be communicatively connected with each other through the network by using wired or wireless connection technology. In some embodiments, the master clock device 210 includes a grandmaster clock (GMC), and such GMC may be an atomic clock capable of providing high time accuracy, such as a Cesium atomic clock or a Rubidium atomic clock, while the network devices 220(1)-220(N) are intermediate node devices with boundary clocks or terminal devices with ordinary clocks. Alternatively, in other embodiments, the master clock device 210 is an intermediate node device with a boundary clock, while the network devices 220(1)-220(N) are intermediate node devices with boundary clocks or terminal devices with ordinary clocks.

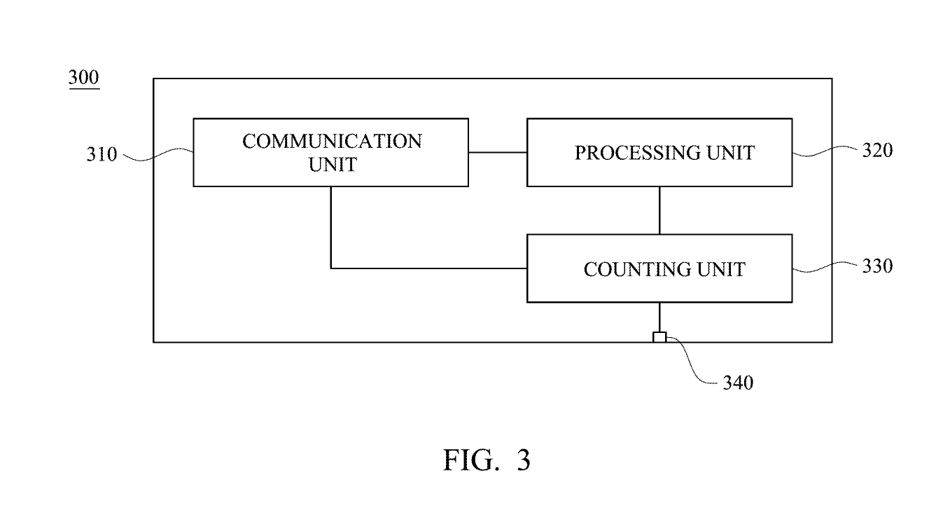

FIG. 3 illustrates a schematic diagram of a network device 300 in accordance with some embodiments of the present invention. The network device 300 may be one of the network devices 220(1)-220(N) shown in FIG. 2. In addition, the network device 300 may be an intermediate node device, such as a switch or a router, or may be a terminal device. The network device 300 sets a counting time, and when the counting time meets a predetermined condition, the network device 300 generates a synchronous pulse signal and transmits the synchronous pulse signal to a communication device, for synchronizing the system times of the network device 300 and the communication device.

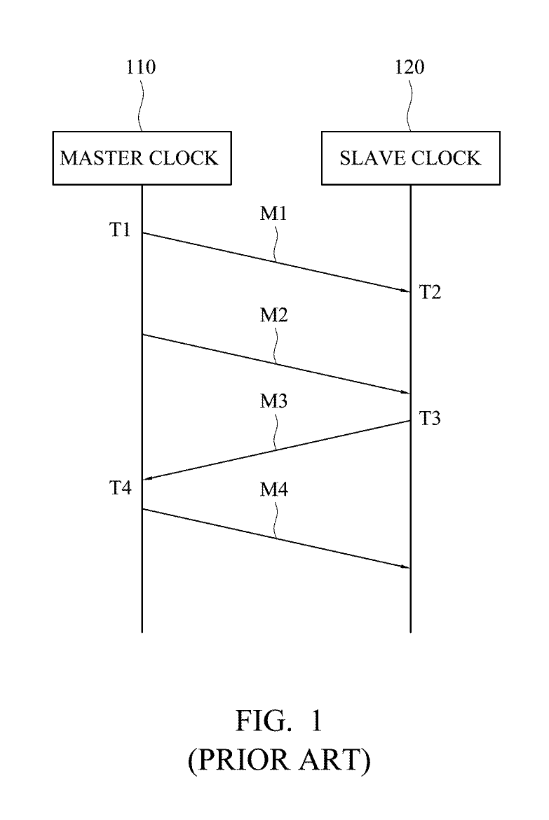

The network device 300 includes a communication unit 310, a processing unit 320, a counting unit 330 and an output port 340. The communication unit 310 is configured to communicatively connect to a master clock device and to perform a time synchronization process with a master clock device. The time synchronization method performed by the network device 300 is a message transmission flow according to the Precision Time Protocol (PTP) shown in FIG. 1, and the network device 300 corresponds to the slave device 120 in FIG. 1.

The processing unit 320 is coupled to the communication unit 310, configured to control the communication unit 310 to perform a time synchronization process for obtaining the time offset of the network device 300 relative to the master clock device. The calculation of the time offset is described in the preceding paragraph, and thus is not repeated herein.

In addition, the processing unit 320 further calculates the processing time elapsed during the time synchronization process. In the embodiments of the present invention, the processing unit 320 reads the system time of the network device 300 before calculating a correction time, and subtracts the time T2 from the read system time to obtain a processing time.

In some embodiments, the processing unit 320 calculates a correction time by subtracting the time offset of the network device 300 relative to the master clock device and the processing time from the system time of the network device 300. In alternative embodiments, the processing unit 320 calculates a correction time by subtracting the time offset of the network device 300 relative to the master clock device from the system time of the network device 300 first, and then updates the correction time by subtracting the processing time from the correction time.

In some embodiments, the processing unit 320 further updates the correction time by subtracting the processing time and the transmission delay from the correction time. Because the transmission delay from the processing unit 320 to the counting unit 330 is approximately fixed, the transmission delay can be further subtracted from the correction time for enhancing time correction accuracy.

The counting unit 330 is coupled to the processing unit 320, setting the counting time of the synchronous pulse signal of the network device 300 by the correction time. When the counting time meets a predetermined condition, the counting unit 330 generates the synchronous pulse signal and controls the output port 340 to output the synchronous pulse signal. The predetermined condition may be that the counting time reaches a predetermined value, and when the counting time increases to the predetermined value, the counting unit 330 generates a synchronous pulse signal and resets the counting time to be zero. Alternative, the predetermined condition may be that the counting time reaches zero, and when the counting time decreases to zero, the counting unit 330 generates a synchronous pulse signal and resets the counting time to be the predetermined value. The predetermined value may be stored in a register (not shown) of the counting unit 330. For example, the correction time and the counting time may be in the unit of nanoseconds, and the counting unit 330 may obtain the counting time by subtracting the correction time from one second (i.e. 10⁹ nanoseconds). When the counting time decreases to zero, the counting unit 330 controls the output port 340 to output a synchronous pulse signal.

According to the abovementioned embodiment, the network device 300 may intermittently generate or transmit the synchronous pulse signal according to the set counting time for synchronizing the system times of the network device 300 and the communication device. The communication device may be exemplarily a terminal device, such as a web camera or a video displayer, or an intermediate node device, such as a switch or a router, but is not limited herein. The network device 300 with a single output port 340 shown in FIG. 3 is just for example, and in other embodiments, the network device 300 may be designed having multiple output ports 340 in accordance with various application demands, for realizing system time synchronization with multiple communication devices.

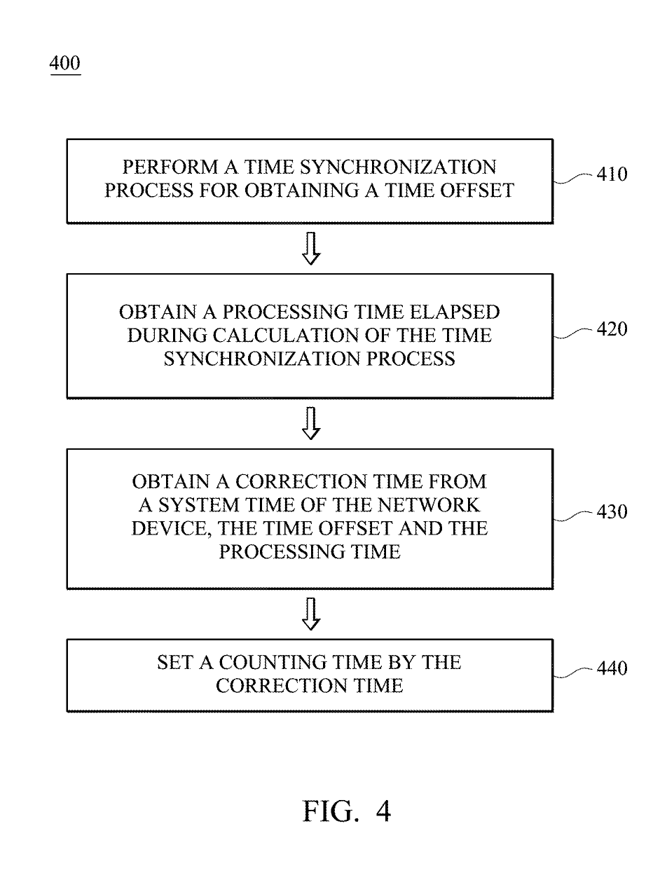

Referring to FIG. 4, FIG. 4 is a flowchart of a time synchronization process 400 in accordance with some embodiments of the present invention. The time synchronization process 400 is adapted to a network device, such as the network device 300 in FIG. 3 and any of the network devices (1)-220(N) of the network system 200 in FIG. 2, and such network device can be an intermediate node or a terminal device.

The time synchronization process 400 includes steps 410-440. In step 410, the network device performs a PDP process (as shown in FIG. 1) with a master clock device for obtaining a time offset of the network device relative to the master clock device.

In step 420, the network device subtracts the system time of the network device corresponding to receiving a follow-up message by the network device from the system time corresponding to calculating the time offset, thereby obtaining a processing time elapsed during calculation of the time synchronization process.

In step 430, the network device calculates the system time of the network device, the time offset and the processing time to obtaining a correction time. In some embodiments, the network device may calculate the correction time by subtracting the time offset of the network device relative to the master clock device and the processing time from the system time of the network device. In alternative embodiments, the network device may calculate the correction time by subtracting the time offset of the network device relative to the master clock device from the system time of the network device first and then updating the correction time by subtracting the processing time from the correction time. In some embodiments, the network device may further update the correction time by subtracting the transmission delay of the network device from the correction time.

In step 440, the network device sets a counting time of a synchronous pulse signal of the network device by the correction time, the counting time used for controlling the network device when to output the synchronous pulse signal. The network device may transmit the synchronous pulse signal to a communication device for synchronizing the system times of the network device and the communication device. The communication device may be exemplarily a terminal device, such as a web camera or a video displayer, or an intermediate node device, such as a switch or a router, but is not limited herein.

The advantage of the present invention is that the updated system time of a network device can be more accurate by subtracting the time elapsed during calculation of performing a time synchronization process with a master clock device. Moreover, the synchronous pulse signal generated according to the present invention may be transmitted to other communication devices for performing system time synchronization on the communication devices, and thus the updated system times of these communication devices can be more accurate.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims.

What is claimed is:

1. A network device, comprising:
a communication unit configured to perform a time synchronization process with a master clock device; and
a processing unit coupled to the communication unit, wherein the processing unit is configured to control the communication unit to perform the time synchronization process for obtaining a time offset of the network device relative to the master dock device, and the processing unit is further configured to calculate a processing time elapsed during the time synchronization process and to obtain a correction time by calculating a system time of the network device, the time offset and the processing time.

2. The network device of claim 1, further comprising:
a counting unit coupled to the processing unit;
wherein the processing unit sets a counting time of the counting unit according to the correction time, and the counting unit generates a synchronous pulse signal according to the counting time.

3. The network device of claim 2, further comprising:
an output port coupled to the counting unit, the output port configured to transmit the synchronous pulse signal to a communication device.

4. The network device of claim 1, wherein the processing unit is further configured to update the correction time by subtracting a transmission delay of the network device from the correction time.

5. The network device of claim 1, wherein the time synchronization process is a precision time protocol (PTP) process, and the processing time is obtained by the processing unit which subtracts the system time corresponding to receiving a follow-up message from the system time corresponding to calculating the time offset.

6. A time synchronization method adapted to a network device, the time synchronization method comprising:
performing a time synchronization process with a master clock device for obtaining a time offset of the network device relative to the master clock device;
subtracting a system time of the network device corresponding to receiving a follow-up message by the network device from the system time corresponding to calculating the time offset, thereby obtaining a processing time elapsed during calculation of the time synchronization process;
obtaining a correction time by calculating the system time of the network device, the time offset and the processing time; and
setting a counting time for generating a synchronous pulse signal by the correction time.

7. The time synchronization method of claim 6, further comprising:
transmitting the synchronous pulse signal to a communication device via an output port of the network device.

8. The time synchronization method of claim 6, further comprising:
updating the correction time by subtracting a transmission delay of the network device from the correction time.

9. A network system, comprising:
a master clock device; and
a network device configured to communicatively connect with the master clock device and to perform a time synchronization process with the master clock device, thereby obtaining a time offset of the network device relative to the master clock device;
wherein the network device is further configured to calculate a processing time elapsed during the time synchronization process and to obtain a correction time by calculating a system time of the network device, the time offset and the processing time, so as to set a counting time of the network device for generating a synchronous pulse signal.

10. The network system of claim 9, wherein the network device is a switch.
